(19) United States
(12) Patent Application Publication
(10) Pub. No.: US 2017/0171519 A1
(43) Pub. Date: Jun. 15, 2017

(54) IMAGE PROJECTING APPARATUS AND CONTROL METHOD THEREOF

(71) Applicant: HYUNDAI MOTOR COMPANY, Seoul (KR)

(72) Inventors: Daeyun AN, Anyang-si (KR); Seunghyun WOO, Seoul (KR); Jongmin OH, Ulsan (KR)

(21) Appl. No.: 15/161,943

(22) Filed: May 23, 2016

(30) Foreign Application Priority Data
Dec. 14, 2015 (KR) 10-2015-0177886

(51) Int. Cl. H04N 9/31; G06F 3/048

(52) U.S. Cl. CPC H04N 9/3179; G06F 3/048

(57) ABSTRACT

An image projecting apparatus includes a first projector which projects a first image onto a projection plane; a second projector which projects a second image onto the projection plane; and a controller which controls projection spots of the images with respect to the projection plane. The image projecting apparatus enables quick and easy prototyping with respect to a multimedia screen.

### CROSS-REFERENCE TO RELATED APPLICATION

This application claims the benefit of priority to Korean Patent Application No. 10-2015-0177886, filed on Dec. 14, 2015 in the Korean Intellectual Property Office, the disclosure of which is incorporated herein by reference.

### TECHNICAL FIELD

The present disclosure relates to an image projecting apparatus and a control method thereof.

### BACKGROUND

An image projecting apparatus provides a large-sized image by magnifying and projecting an image to a screen. The image projecting apparatus includes a light source, an illumination system which focuses a light emitted from the light source. A display displays the image by the light provided from the illumination system. A lens system projects the image shown by the display to the screen.

Recently, a portable image projecting apparatus has been widely used, in which an installation position and a projecting angle of the image projecting apparatus vary and new image systems are progressively being developed to apply such variations.

### SUMMARY

An aspect of the present disclosure provides an image projecting apparatus which includes a plurality of projectors to easily change a projection image, and a control method thereof.

Another aspect of the present disclosure provides an image projecting apparatus which collects image information of a projection plane and controls a projecting position of an image based on the collected image information, and a control method thereof.

An image projecting apparatus in accordance with an embodiment includes an input which receives a setting command with respect to a projection image of a projector; a first projector which projects a first image onto a projection plane; and a second projector which projects a second image onto the projection plane.

The first image may include a background image with respect to the second image.

The second image may include an image which is an evaluation target.

The second image may include an image which is projected onto a front side of the first image.

The image projecting apparatus further includes a controller configured to projection spots of first and second images with respect to the projection plane.

The image projecting apparatus further includes a collector that collects image information which is projected onto the projection plane.

The controller may control the projection spots of the first and second images with respect to the projection plane based on the collected image information.

The controller may extract feature points of collected images and control the projection spots of the first and second images with respect to the projection plane based on information of the extracted feature points.

The controller may control a projection spot of the other image with respect to the projection plane while one of the first and second images is fixed.

The controller may include a processor which controls the projection spots of the first and second images with respect to the projection plane.

The controller may control an operation of a projector of at least one of the first and second projectors to control the projection spots of the first and second images with respect to the projection plane.

The controller may control to synchronize frequencies of the images.

The input unit may receive a setting command about at least one of a form, a size, a type, a font, and a color of a projection image.

A control method of an image projecting apparatus according to another embodiment in the present disclosure includes receiving a setting command about a projection image of a projector; projecting a first image onto a projection plane; and projecting a second image onto the projection plane.

Controlling projection spots of images with respect to the projection plane may be further included.

The controlling of the projection spots of the images with respect to the projection plane may include collecting image information which is projected onto the projection plane.

The controlling of the projection spots of the images with respect to the projection plane may include extracting feature points of the images based on the collected image information and controlling the projection spots of the images with respect to the projection plane based on information of the extracted feature points.

The controlling of the projection spots of the images with respect to the projection plane may include controlling a projection spot of the other image with respect to the projection plane while one of the first and second images is fixed.

The control method of an image projecting apparatus further includes synchronizing frequencies of the images.

The receiving of the setting command about the projection image of the projection unit may include receiving a setting command about at least one of a form, a size, a type, a font and a color of the projection image.

### BRIEF DESCRIPTION OF THE DRAWINGS

These and/or other aspects of the invention will become apparent and more readily appreciated from the following description of the embodiments, taken in conjunction with the accompanying drawings.

FIG. 1 is a conceptual diagram of an image projecting apparatus in accordance with one embodiment in the present disclosure.

FIG. 2 is a control block diagram of the image projecting apparatus in accordance with one embodiment in the present disclosure.

FIG. 3 is a conceptual diagram of an image projecting apparatus according to another embodiment in the present disclosure.

FIG. 4 is a control block diagram of the image projecting apparatus according to another embodiment in the present disclosure.

FIG. 5 is a view illustrating a process of matching images based on information of feature points.

FIG. 6 is a view illustrating an example in which the image projecting apparatus in accordance with one embodiment in the present disclosure is provided in an evaluation process of a user interface.

FIG. 7 is a view illustrating an example in which the image projecting apparatus in accordance with one embodiment in the present disclosure is provided in an image production process.

FIG. 8 is a view illustrating an example in which the image projecting apparatus in accordance with one embodiment of the present disclosure is provided in an output of an advertising text.

FIG. 9 is a flowchart illustrating a control process of the image projecting apparatus in accordance with one embodiment in the present disclosure.

FIG. 10 is a flowchart illustrating a control process the image projecting apparatus in accordance with another embodiment in the present disclosure.

### DETAILED DESCRIPTION

Reference will now be made in detail to exemplary embodiments in the present disclosure, examples of which are illustrated in the accompanying drawings, wherein like reference numerals refer to like elements throughout.

The disclosed embodiments relate to an image projecting apparatus and a control method thereof.

The image projecting apparatus according to the present disclosure and the control method thereof are provided to prototype a multimedia image. More specifically, the image projecting apparatus, which is capable of changing user interface (UI) elements while a basic background image is fixed, is provided.

Hereinafter, the image projecting apparatus and the control method thereof will be described in detail with reference to the accompanying drawings.

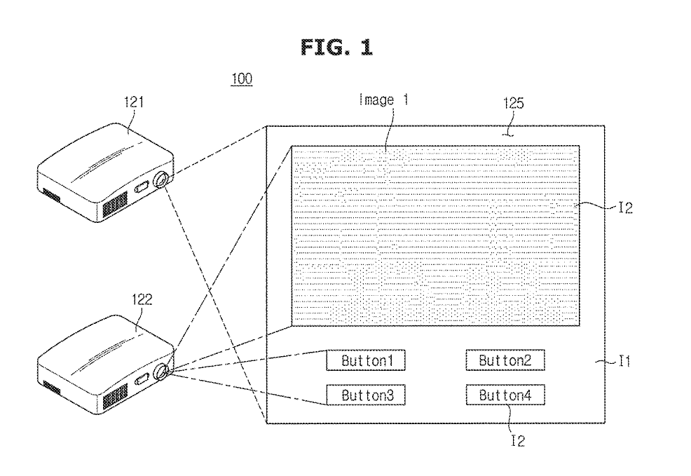

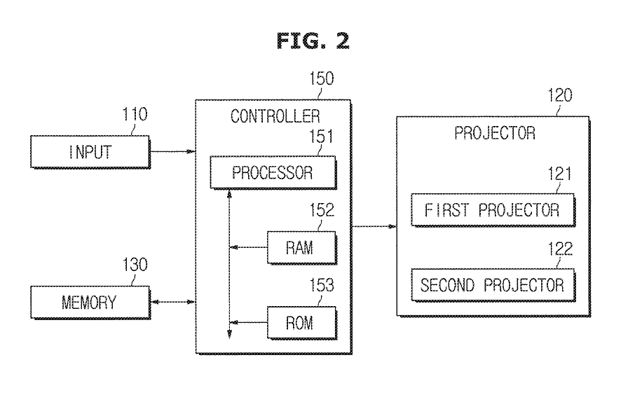

FIG. 1 is a conceptual diagram of an image projecting apparatus in accordance with one embodiment in the present disclosure, and FIG. 2 is a control block diagram of an image projecting apparatus in accordance with one embodiment in the present disclosure.

With reference to FIGS. 1 and 2, an image projecting apparatus 100 may include an input 110, a projector 120, a memory 130, and a controller 150.

The input 110 is configured to receive control signals about various functions of the image projecting apparatus 100 from a user and to transfer the received control signals to the controller 150. For example, the input 110 is capable of receiving a setting command for a projection image of the projector 120 from the user, and the received setting command information may be transferred to the controller 150. Here, the setting command of the image may be a concept including commands about a type, a size, a color, and a projection spot of the image which is projected from the projector 120.

The input 110 may be implemented as a pressure-based type button device or a touch panel type. In accordance with the present disclosure, the input 110 of control devices (e.g. a control PC) may function as an input unit for the image projecting apparatus 100.

The projector 120 is configured to project the image onto a projection plane 125. The image projecting apparatus 100 in accordance with the present disclosure may include a first projector 121 which projects a first image I1 onto the projection plane 125 and a second projector 122 which projects a second image I2 onto the projection plane 125. FIGS. 1 and 2 show that the first projector 121 and the second projector 122 are included for ease of illustration, but the example of providing the projector 120 is not limited thereto. A third projector and a fourth projector may be also included as necessary. Hereinafter, a case in which the projector 120 includes the first projector 121 and the second projector 122 will be described as an example.

The first projector 121 and the second projector 122 may be fixedly disposed at a predetermined position or may be movably disposed. When the first and second projectors 121 and 122 are movably disposed, a process to match the first and second images I1 and I2 is necessary. The process of matching the first and second images I1 and I2 will be described below. Here, it is assumed that the first and second projectors 121 and 122 are fixedly disposed at the predetermined position.

The first projector 121 may project the first image I1 onto the projection plane 125, and the second projector 122 may project the second image I2 onto the projection plane 125. For example, the first image I1 may be a fixed background image, and the second image I2 may be an evaluation target image which is shown prior to the first image I1. Here, the evaluation target image may be a concept including a widget, a menu, a text, an image (a symbol, a logo, etc.), a video, etc.

Because a user is available to freely choose forms, types, etc. of images which are projected from the first and second projectors 121 and 122, it is possible to provide a further improved UI prototyping tool through the image projecting apparatus 100.

The projector 120 may be an apparatus for projecting an image which is magnified by a lens onto a screen after receiving signals from video devices including a television, a videocassette recorder (VCR), a personal computer (PC), and a camcorder, etc. The projector 120 may include a cathode ray tube (CRT) projector, a liquid crystal display (LCD) projector, a digital light processing (DLP) projector, and so on.

The memory 130 may store a variety of data, programs or applications for operating and controlling the image projecting apparatus 100. More specifically, a control program to control the image projecting apparatus 100, programs such as an exclusive application initially provided from a manufacturer or a universal application downloaded from an external source, etc. may be stored. For example, the memory 130 may store a program to control a projection spot of the image projected from the projector 120.

The memory 130 may store a UI related to a program or an application to operate and control the image projecting apparatus 100, and objects (e.g. an image, a text, an icon, a button, etc.) to provide the UI.

The memory 130 may include at least one storage medium of a flash memory, a hard disc, a memory card, a read-only memory (ROM), a random access memory (RAM), an electrically erasable programmable read-only memory (EEPROM), a programmable read-only memory (PROM), a magnetic memory, a magnetic disc, and an optical disc.

The controller 150 controls overall operations of the image projecting apparatus 100 and signal flows between internal components of the image projecting apparatus 100, and performs a function of data processing. When the controller 150 receives a control command from the user or a preset condition is satisfied, the controller 150 runs a program or an application stored in the memory 130.

The controller 150 may include a processor 151 and a ROM 153 having a control program or an application for controlling the image projecting apparatus 100 stored. A RAM 152 stores signals or data received from outside the image projecting apparatus 100 or is used as a storage area corresponding to a variety of tasks performed in the image projecting apparatus 100. Hereinafter, the ROM 153 and the RAM 152 of the controller 150 may include the ROM and the RAM of the memory 130. For example, the controller 150 may include a processing board such that the processor 151, the RAM 152, and the ROM 153 are mounted on a separate circuit board which is electrically connected with the controller 150.

The controller 150 may synchronize frequencies of the first image I1 and the second image I2. When images having frequencies different from each other are matched and provided, the images are not properly presented due to flickering, blurring, horizontal interference, etc., thereby causing a user visual fatigue. Therefore, the controller 150 may synchronize the frequencies between the first and second projectors 121 and 122 and image sources, and may control to synchronize the projection frequencies of the first and second projectors 121 and 122 in accordance with the present disclosure.

The controller 150 may control sizes, types, etc. of the first image I1 and the second image I2, and may prioritize the first image I1 and the second image I2 with respect to the projection plane 125. For example, when the first image I1 is provided as a background image with respect to the second image I2, and the second image I2 is a UI which is an evaluation target, the second image I2 may be projected onto the projection plane 125 prior to the first image I1.

Hereinafter, an image projecting apparatus in accordance with another embodiment will be described,

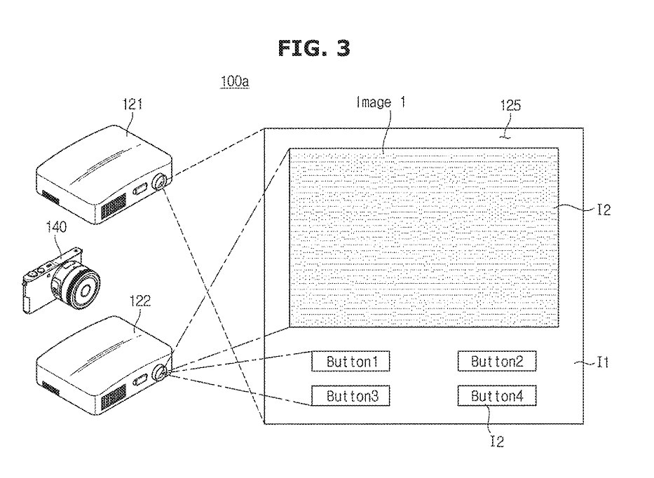

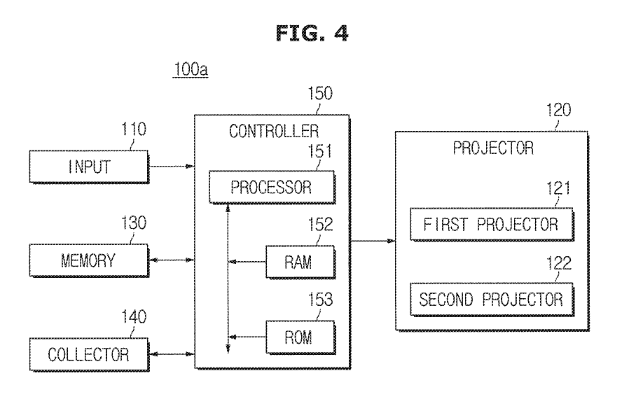

FIG. 3 is a conceptual diagram of an image projecting apparatus in accordance with another embodiment in the present disclosure, and FIG. 4 is a control block diagram of an image projecting apparatus in accordance with another embodiment in the present disclosure.

With reference to FIGS. 3 and 4, an image projecting apparatus 100a according to another embodiment may include the input 110, the projector 120, the memory 130, a collector 140, and the controller 150. The input 110, the projector 120, the memory 130, and the controller 150 in FIGS. 3 and 4 are substantially identical with the configurations of FIGS. 1 and 2, and therefore, differences from FIGS. 1 and 2 will be mainly explained below.

The image projecting apparatus 100a according to another embodiment is different from the image projecting apparatus 100 illustrated in FIGS. 1 and 2 in which the image projecting apparatus 100a further includes the collector 140.

The collector 140 may collect information of an image which is projected onto the projection plane 125 and send the collected image information to the controller 150. The collector 140 may include a camera, but the present disclosure is not limited thereto. The image information collected by the collector 140 may be transferred to the controller 150 and may be provided in a calibration process of the first image I1 and the second image I2.

The controller 150 may control projection spots of the first and second images I1 and I2 with respect to the projection plane 125 based on the image information collected by the collector 140.

The image projecting apparatus 100a projects independent images onto the projection plane 125 through the first and the second projectors 121 and 122, thereby providing an image formed by overlapping the first image I1 and the second image I2. That is, since the image which is formed by a combination of the first image I1 and the second image I2 is provided to the user, it is necessary to perform a process matching the first image I1 and the second image I2 to provide a more accurate image to the user. In particular, when the first and the second projection units 121 and 122 are movably provided, it is necessary to perform a process for controlling the projection spots of the first and the second images I1 and I2.

In controlling of the projection spots of the first and the second images I1 and I2 with respect to the project plane 125 by the controller 150, the projection spot of the second image I2 is controlled with respect to the projection plane 125 while the projection spot of the first image I1 is fixed. The controller 150 may determine the projection spot of the second image I2 with respect to the first image I1 based on the stored information in the memory 130. The controller 150 may control the projection spot of the second image I2 with respect to the first image I1 through software, and may control the projection spot of the second image I2 by controlling an operation of an actuator of the second projector 122 in accordance with the present disclosure.

The controller 150 may control the projection spots of the first and second images I1 and I2 with respect to the projection plane 125 by extracting feature points P of the first and second images I1 and I2. Specifically, the controller 150 may extract the feature points P of the first and second images I1 and I2, and may control the projection spots of the images by matching information of the extracted feature points P.

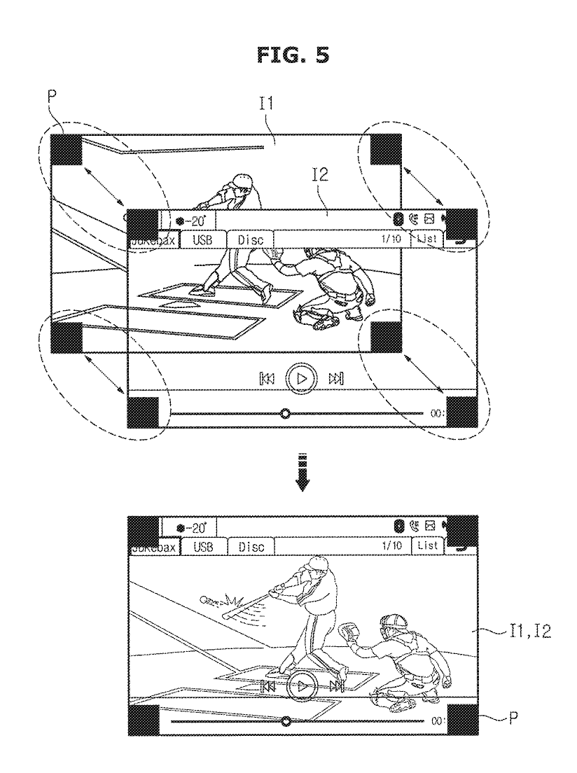

FIG. 5 is a view illustrating a process of matching images based on information of feature points.

With reference to FIG. 5, the collector 140 may collect information of the first and second images I1 and I2 and may transfer the same to the controller 150. The controller 150 may extract feature points P of the first and second images I1 and I2 based on the image information collected by the collector 140, and may control the projection spots of the images with respect to the projection plane 125 based on the information of the extracted feature points P.

For example, the controller 150 may extract the feature points P at corners of the first image I1 and the feature points P at corners of the second image I2 based on the image information received from the collector 140, and may match each of the feature points P. A process of matching the feature points P may include comparing sizes and shapes of the feature points P which are to be matched and calibrating sizes and shapes of the images.

Hereinafter, the image projecting apparatus according to the present disclosure will be described as an example for ease of illustration.

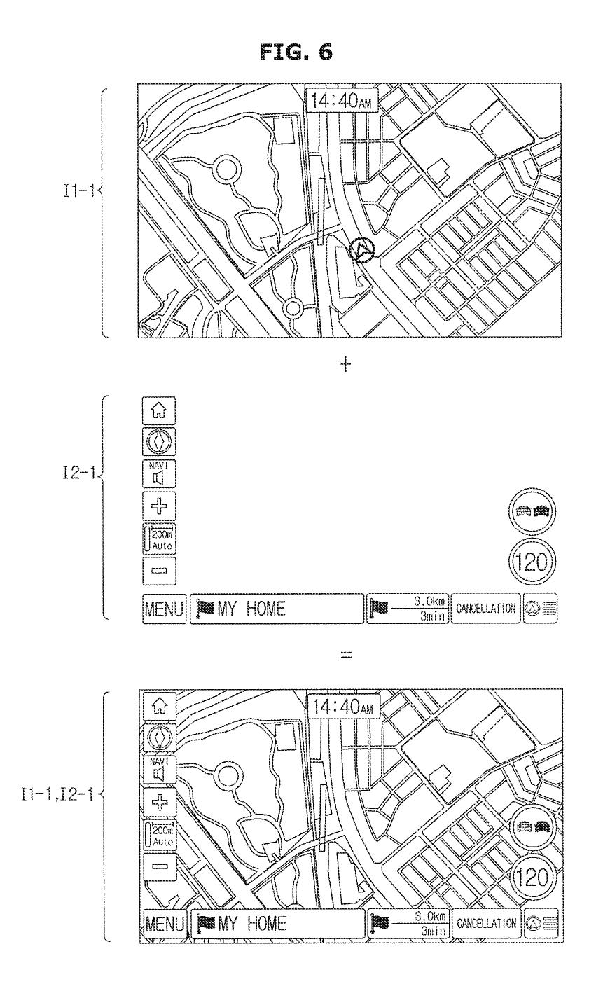

FIG. 6 is a view illustrating an example in which an image projecting apparatus in accordance with one embodiment in the present disclosure is provided in a UI evaluation process.

With reference to FIG. 6, the first projector 121 may project a background image onto the projection plane 125, and the second projector 122 may project UI elements onto the projection plane 125.

For example, the background image may be a navigation screen, and the UI elements may be an execution menu, a widget icon, etc. which are provided along with the navigation image. The example of the background image and the UI elements are not limited to the above description. That is, the background image may be a center fascia image of a vehicle, and the UI elements may be center fascia manipulation buttons and so on.

In FIG. 6, the first projector 121 projects a navigation screen I1-1 onto the projection plane 125, and the second projector 122 projects an execution menu image I2-1 of the navigation screen onto the projection plane 125. Image sources I1-1 and I2-1 as illustrated in FIG. 6 may be provided in the UI evaluation process.

In general, a leading UI evaluation test is performed to verify usability of an UI when designing the UI. To acquire accurate experimental data when performing the UI evaluation test, it is necessary to secure data by performing the evaluation test several times.

In the image projecting apparatus according to the present disclosure, fast and easy prototyping on a multimedia screen is available by controlling a UI element image I2-1 which is projected from the second projector 122 while a background image I1-1 which is projected from the first projector 121 is fixed. Therefore, when the image projecting apparatus according to the present disclosure is used, a leading evaluation test on usability of the UI may be performed more efficiently.

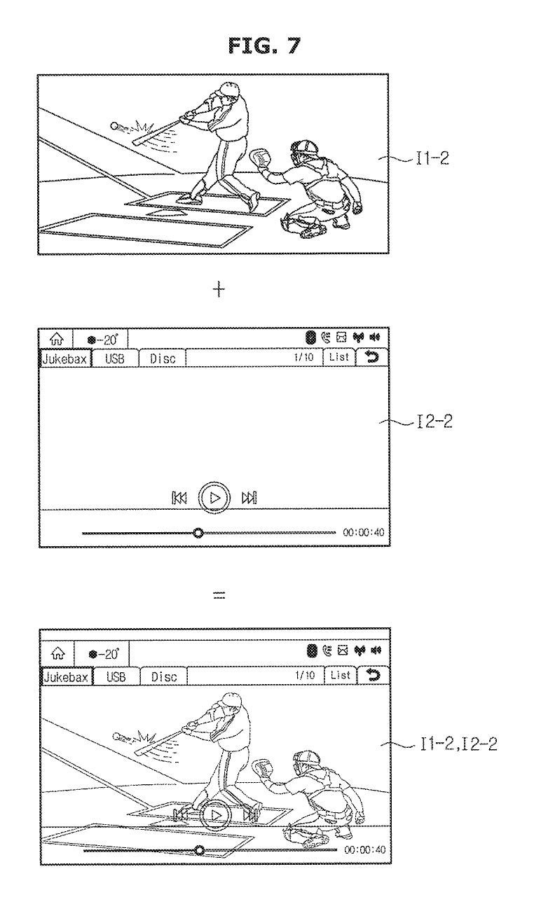

FIG. 7 is a view illustrating an example where an image projecting apparatus in accordance with one embodiment in the present disclosure is provided in an image production process.

With reference to FIG. 7, the first projector 121 may project an image I1-2 which becomes a background to the projection plane 125, and the second projector 122 may project UI elements I2-2 onto the projection plane 125. Here, the UI elements may include an image playback button, a stop button, a progress bar, etc.

The user may differently set size, type, etc. of the UI elements which are projected from the second projector 122 as necessary. That is, while the background image projected from the first projector 121 is fixed, the image projected from the second projector 122 may be freely changed to produce image sources I1-2 and I2-2, thereby the user is capable of quickly and easily prototyping a multimedia screen.

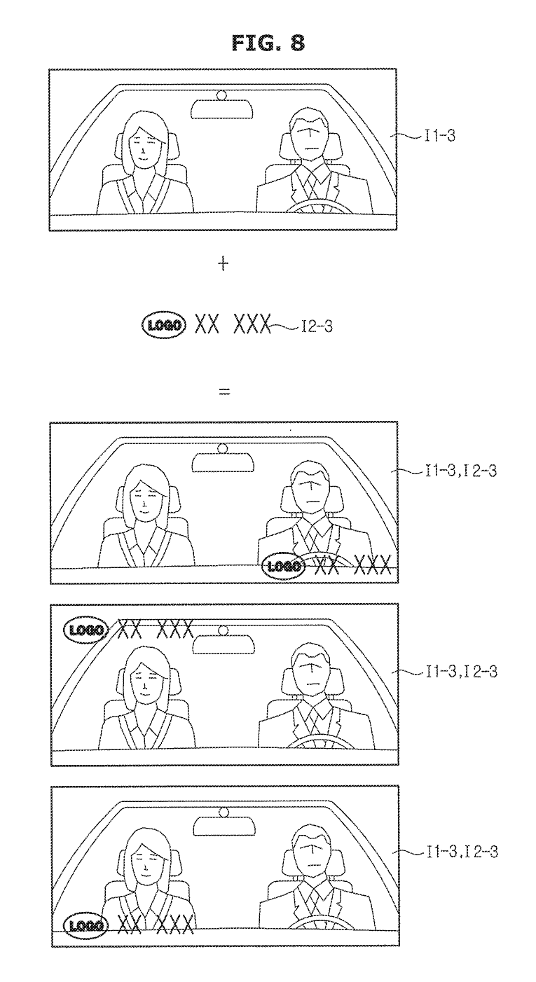

FIG. 8 is a view illustrating an example where an image projecting apparatus in accordance with one embodiment in the present disclosure is provided in an output of an advertising text.

With reference to FIG. 8, the first projector 121 may project a background image I1-3 onto the projection plane 125, and the second projector 122 may project UI elements I2-3 onto the projection plane 125. Here, the background image I1-3 may include an advertising image, and the UI elements I2-3 may include an advertising text, a company logo, a symbol, etc.

The user may differently set a font, a projection spot, etc, of the advertising text which is projected from the second projector 122 as necessary. That is, while the advertising image which is projected from the first projector 121 is fixed, a projecting position and a size of the advertising text projected from the second projector 122 may be freely changed to produce an image source, thereby the user is capable of checking and editing the image source in real-time.

Above, various exemplary embodiments of the image projecting apparatus have been described, however, these embodiments in the present disclosure are not limited to the above embodiments.

For example, the image projecting apparatus according to the present disclosure may be utilized in outputting an advertising text and an image in a movie theatre, and the like. In this case, after producing a movie or an advertising image which becomes a frame for a background image, a text, an image, etc. which are included in the image may be differently provided depending on an environment of demonstration. That is, images may be provided in a wide variety of types in accordance with situations by changing a text, an image, etc. which are projected from the second projector 122.

Hereinafter, a control method of an image projecting apparatus in accordance with the present disclosure will be described.

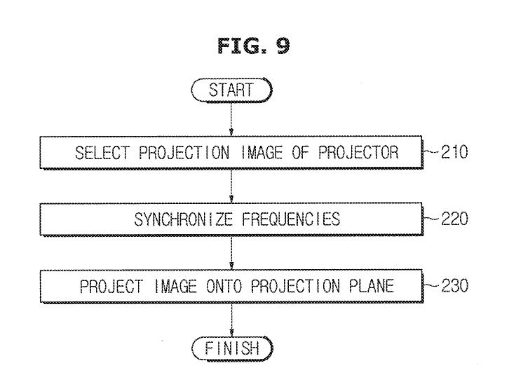

FIG. 9 is a flowchart illustrating a process of controlling an image projecting apparatus in accordance with one embodiment in the present disclosure.

With reference to FIG. 9, the process of controlling the image projecting apparatus in accordance with the present disclosure includes selecting a projection image of the projector 120 (S210); synchronizing frequencies (S220); and projecting the image onto the projection plane 125 (S230).

First, the step of selecting the projection image which is projected from the projector may be performed (S210).

The step of selecting the projection image of the projector 120 may include selecting a first image I1 which is projected from the first projector 121 and selecting a second image I2 which is projected from the second projector 122. Here, the first image I1 may include a background image, and the second image I2 may include UI designing elements (e.g. a menu, a widget, other images, etc.) which are evaluation targets (S210).

After the image which is projected from the projector 120 is selected, the frequencies may be synchronized (S220). The step of synchronizing the frequencies may include synchronizing frequencies between the projector 120 and an image source and synchronizing projection frequencies between the projectors 120.

Next, the step of projecting the image may be performed (S230). The step of projecting the image may include projecting the first image I1 from the first projector 121 onto the projection plane 125 and projecting the second image I2 from the second projector 122 onto the projection plane 125.

When the image source is generated by combining the first image I1 and the second image I2, a user interaction based upon the generated image source may be performed. The step of performing the user interaction may include manipulating the designed image source screen and collecting information of the manipulating of a UI.

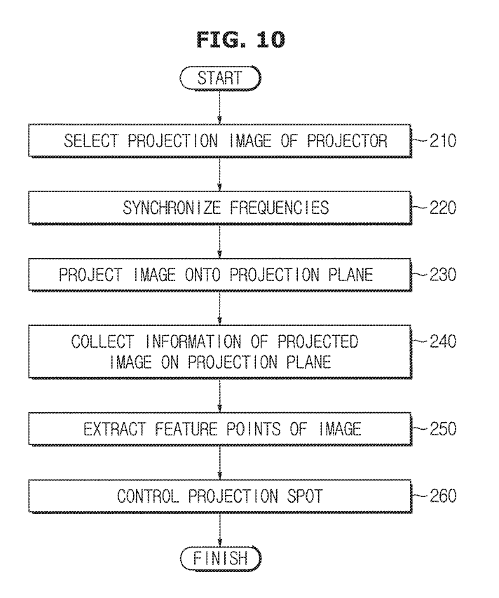

FIG. 10 is a flowchart illustrating a process of controlling an image projecting apparatus in accordance with another embodiment in the present disclosure.

With reference to FIG. 10, the process of controlling the image projecting apparatus 100a may include: selecting a projection image of the projector 120 (S210); synchronizing frequencies (S220); projecting an image onto the projection plane 125 (S230); collecting information of the projected image on the projection plane 125 (S240); extracting feature points P of the image based on the collected information of the image (S250); and controlling a projection spot based on the information of the feature points P (3260).

The process of controlling the image projecting apparatus 100 in FIG. 10 is different from the process of controlling the above-described image projecting apparatus in FIG. 9 in terms of controlling the projection spots based on the information of the feature points P. Hereinafter, the difference from FIG. 9 will be mainly explained for ease of illustration.

In the process of controlling the image projecting apparatus 100 in accordance with the present invention, the information of the projected image on the projection plane 125 may be collected after operation S230 (S240).

The collector 140 may collect the information of the projected image on the projection plane 125, and may transfer the collected image information to the controller 150.

When the collected image information is transferred to the controller 150, the feature points P of the image may be extracted. The controller 150 may perform image processing on the collected image information and may extract the feature points P of the first image I1 and the second image I2 (250).

When the feature points P of the images are extracted, a process that controls sizes and projection spots of the first image I1 and the second image I2 may be performed by analyzing differences in the positions and the sizes of each of the feature points P based on the information of the extracted feature points P.

Here, the sizes of the first image I1 and the second image I2 may be controlled by software. In addition, the projection spots of the first image I1 and the second image I2 may be controlled by software, and may be controlled by a method which controls the operations of the first and second projectors 121 and 122 in accordance with the present disclosure (S250).

A process thereafter is identical to the aforementioned FIG. 9, and thus, repetitive descriptions of FIG. 9 will be omitted.

Above, the image projecting apparatus in accordance with the present disclosure and various embodiments of a control method thereof have been described. However, the technological scope of the invention is not limited to the above-described embodiments, and it should be broadly appreciated that changes easily conceived by those skilled in the art may be made within the scope of the present invention.

An image projecting apparatus and a control method in accordance with the exemplary embodiments, it is possible to provide a further improved UI prototyping tool. More specifically, it is possible to promote efficiency of an evaluation by easily providing a UI as an evaluation target which is provided during a manufacture and an evaluation process of the UI.

Further, by being provided in the image production process and the like, it is possible to freely give a demonstration of a text, a symbol, a logo, etc. with respect to the same background image.

Although a few embodiments have been shown and described, it should be appreciated by those skilled in the art that changes may be made in these embodiments without departing from the principles and spirit of the invention, the scope of which is defined in the claims and their equivalents.

1. An image projecting apparatus comprising:
an input configured to receive a setting command with respect to a projection image of a projector;
a first projector configured to project a first image onto a projection plane; and
a second projector configured to project a second image onto the projection plane,
wherein the first image includes a background image with respect to the second image, and
wherein the second image includes an evaluation target image.

2.-3. (canceled)

4. The image projecting apparatus according to claim 1, wherein the second image is projected onto a front side of the first image.

5. The image projecting apparatus according to claim 1, further comprising:
a controller configured to control projection spots of the first and second images with respect to the projection plane.

6. The image projecting apparatus according to claim 5, further comprising:
a collector configured to collect image information which is projected onto the projection plane.

7. The image projecting apparatus according to claim 6, wherein the controller controls the projection spots of the first and second images with respect to the projection plane based on the collected image information.

8. The image projecting apparatus according to claim 7, wherein the controller extracts feature points of collected image information and controls the projection spots with respect to the projection plane based on information of the extracted feature points.

9. The image projecting apparatus according to claim 5, wherein, while one of the first and second images is fixed, the controller controls a projection spot of the other image among the first and second images with respect to the projection plane.

10. The image projecting apparatus according to claim 5, wherein the controller comprises:
a processor configured to control the projection spots of the first and second images with respect to the projection plane.

11. The image projecting apparatus according to claim 5, wherein the controller controls an operation of at least one of the first and second projectors to control the projection spots of the first and second images with respect to the projection plane.

12. The image projecting apparatus according to claim 5, wherein the controller synchronizes frequencies of the first and second images.

13. The image projecting apparatus according to claim 1, wherein the input receives a setting command of at least one of a form, a size, a type, a font, and a color of the projection image.

14. A control method of an image projecting apparatus, the method comprising:
receiving, by an input, a setting command of a projection image of a projector;
projecting, by a first projector, a first image onto a projection plane; and
projecting, by a second projector, a second image onto the projection plane,
wherein the first image includes a background image with respect to the second image, and
wherein the second image includes an evaluation target image.

15. The method according to claim 14, further comprising:
controlling projection spots of the first and second images with respect to the projection plane.

16. The method according to claim 15, wherein the step of controlling the projection spots of the first and second images with respect to the projection plane comprises:
collecting image information which is projected onto the projection plane.

17. The method according to claim 16, wherein the step of controlling of the projection spots of the first and second images with respect to the projection plane comprises:
extracting feature points of the first and second images based on the collected image information; and
controlling the projection spots of the first and second images with respect to the projection plane based on information of the extracted feature points.

18. The method according to claim 15, wherein the step of controlling the projection spots of the images with respect to the projection plane comprises:
controlling, while any one of the first and second images is fixed, a projection spot of the other image of the first and second images with respect to the projection plane.

19. The method according to claim 14, further comprising:
synchronizing frequencies of the of the first and second images.

20. The method according to claim 14, wherein the step of receiving the setting command of the projection image of the projector comprises:
receiving a setting command of at least one of a form, a size, a type, a font, and a color of the projection image.
